(19) United States
(12) Patent Application Publication
(10) Pub. No.: US 2024/0045912 A1
(43) Pub. Date: Feb. 8, 2024

(54) SYSTEMS AND METHODS FOR GENERATING ITINERARY-RELATED RECOMMENDATIONS AND/OR PREDICTIONS FOR A USER

(71) Applicant: Capital One Services, LLC, McLean, VA (US)

(72) Inventors: Abdelkader BENKREIRA, New York, NY (US); Tyler MAIMAN, Melville, NY (US); Brendan WAY, Brooklyn, NY (US)

(73) Assignee: Capital One Services, LLC, McLean, VA (US)

(21) Appl. No.: 17/818,220

(22) Filed: Aug. 8, 2022

(51) Int. Cl. G06F 16/9535; G06F 16/951; G06F 16/9537; G06F 9/451; G06Q 50/14; G06F 16/9538

(52) U.S. Cl. CPC G06F 16/9535; G06F 16/951; G06F 16/9537; G06F 9/451; G06Q 50/14; G06F 16/9538

(57) ABSTRACT

A computer-implemented method may include receiving, from a module or an application installed on a user device of an individual, data related to first input to a first user interface for an activity associated with a location. The method may further include gathering additional data based on receiving the data related to the first input. The additional data may include one or more prior activities of the individual and one or more activities of interest to the individual. The method may include inputting the received data and the gathered additional data to one or more trained machine learning models. The method may include generating, based on the first output from the one or more trained machine learning models, second output related to the activity. The method may include sending a first instruction associated with causing a second user interface to be displayed on a display of the user device.

### TECHNICAL FIELD

Various embodiments of this disclosure relate generally to using machine learning techniques for generating recommendations and/or predictions and, more particularly, to systems and methods for generating itinerary-related recommendations and/or predictions for a user.

### BACKGROUND

Individuals may use a web browser or an application on a user device to book a trip to a destination (e.g., to make a reservation for transportation, such as a flight, train, or rental car, to make a reservation for lodging, such as at a hotel or a short-term rental, etc.) and/or to book activities at the destination (e.g., dining, entertainment, etc.). These trip-related tasks may consume a significant amount of computing resources and/or time due to the individual having to perform web searches for available transportation and/or activities. In addition, conflicts, e.g., between activities at or near the individual's home location and the trip may arise subsequent to booking the trip, which may cause the individual to cancel or modify the trip. This may waste additional time and computing resources, and may also cost the individual a significant amount of money due to cancelation or re-scheduling fees imposed by vendors providing transportation, lodging, dining, entertainment, etc. related to the trip. Thus, conventional techniques for booking and/or modifying a trip, including the foregoing, may fail to generate recommendations or predictions related to the trip that might otherwise go unaccounted for when the individual books the trip.

This disclosure may address one or more of the above-referenced challenges and/or other challenges in the art. However, the above-referenced challenges are provided merely as examples and the claims do not necessarily address any or all of the above-referenced challenges. Furthermore, the disclosure may address challenges not explicitly enumerated in the disclosure. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for generating itinerary-related recommendations and/or predictions for a user.

A computer-implemented method for activity-related output may include receiving, by a server device and from a module or an application installed on a user device of an individual, data related to first input to a first user interface for an activity associated with a location based on a selection of a user interface element to initiate processing of the first input. The method may further include gathering additional data based on receiving the data related to the first input. The additional data may include one or more prior activities of the individual gathered from one or more computing systems. The additional data may further comprise one or more activities of interest to the individual gathered from the one or more computing systems, gathered from a profile of the individual, gathered using a web crawler, or gathered using computer vision. The method may include inputting the received data and the gathered additional data to one or more trained machine learning models. First output from the one or more trained machine learning models may include one or more characteristics of the location or one or more characteristics of the one or more activities of interest. The method may include generating, based on the first output from the one or more trained machine learning models, second output related to the activity. The second output may include one or more alternative locations, or one or more activities for the individual at the location. The method may include sending a first instruction associated with causing a second user interface to be displayed on a display of the user device. The second user interface may include the second output. The method may include sending, based on second input to the second user interface, a second instruction to modify the initiated processing.

A server device may include at least one memory storing instructions and at least one processor executing the instructions to perform operations for activity-related output. The operations may include receiving, from a user device of an individual, data related to first input to a first user interface for an activity associated with a trip to a destination based on a selection of a user interface element to initiate processing of the first input. The operations may include gathering additional data based on receiving the data related to the first input. The additional data may include one or more prior activities of the individual and one or more activities of interest to the individual. The operations may include inputting the received data and the gathered additional data to one or more trained machine learning models. First output from the one or more trained machine learning models may include one or more characteristics of the destination or one or more characteristics of the one or more activities of interest. The operations may include generating, based on the first output from the one or more trained machine learning models, second output related to the activity. The second output may include one or more alternative destinations or one or more events for the individual at the destination. The operations may include sending a first instruction associated with causing a second user interface to be displayed on a display of the user device. The second user interface may include the second output.

A non-transitory computer-readable medium may store instructions that, when executed by a processor, cause the processor to perform a method for activity-related output. The method may include receiving, by a server device and from a module or an application installed on a user device of an individual, data related to first input to a first user interface for an activity associated with a location based on selection of a user interface element to initiate processing of the first input. The method may include gathering additional data based on receiving the data related to the first input. The method may include inputting the received data and the gathered additional data to one or more trained machine learning models. First output from the one or more trained machine learning models may include one or more characteristics of the location or one or more characteristics of the one or more activities of interest. The method may include generating, based on the first output from the one or more trained machine learning models, second output related to the activity. The second output may include one or more alternative locations, or one or more events for the individual at the location. The method may include sending a first instruction associated with causing a second user interface to be displayed on a display of the user device. The second user interface may include the second output.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for generating itinerary-related recommendations and/or predictions for a user, according to one or more embodiments.

FIG. 2 depicts a flowchart of an exemplary method of generating itinerary-related recommendations and/or predictions for a user, according to one or more embodiments.

FIGS. 3A-3D depict an example of generating itinerary-related recommendations and/or predictions for a user, according to one or more embodiments.

FIGS. 4A-4E depict an example of user interface operations related to generating itinerary-related recommendations and/or predictions for a user, according to one or more embodiments.

FIG. 5 depicts an example of a computing device, according to one or more embodiments.

### DETAILED DESCRIPTION OF EMBODIMENTS

According to certain aspects of the disclosure, methods and systems are disclosed for generating itinerary-related recommendations and/or predictions for a user, e.g., to recommend and/or predict modifications to the itinerary. Conventional techniques may not be suitable for generating such recommendations and/or predictions. For example, conventional techniques may not monitor trip-planning activities of the user in real-time (or near real-time) and recommend modifications to the itinerary, and thus result in wasted computing resources and/or time when the user has to later make modifications to the trip. Accordingly, improvements in technology relating to systems used for trip planning may be needed.

As will be discussed in more detail below, in various embodiments, systems and methods are described for using a machine learning model to generate itinerary-related recommendations and/or predictions. Some embodiments may utilize a trained machine learning model. By training a machine-learning model, e.g., via supervised or semi-supervised learning, to learn associations between user-related data and itinerary-related data and itinerary modification data, the trained machine-learning model may be usable to generate and/or predict modifications to the user's itinerary.

Reference to any particular activity may be provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

The disclosure may use certain terms or phrases to describe the disclosed embodiments. Any definition provided for such terms or phrases should be considered exemplary and non-limiting. The singular forms “a,” “an,” and “the” may include plural referents unless the context dictates otherwise. The term “exemplary” may be used in the sense of “example” rather than “ideal.” The terms “comprises,” “comprising,” “includes,” “including,” or other variations thereof, may cover a non-exclusive inclusion such that a process, method, or product that comprises a list of elements does not necessarily include only those elements, but may include other elements not expressly listed or inherent to such a process, method, article, or apparatus. The term “or” may be used disjunctively, such that “at least one of A or B” includes, (A), (B), (A and A), (A and B), etc. The term “and/or” may include all permutations, combinations, sub-combinations, and individual items listed. For example, a list that includes “A and/or B” may cover situations that include item A alone, item B alone, and a combination of items A and B.

It will also be understood that, although the terms first, second, third, etc. are, in some instances, used herein to describe various elements, these elements should not be limited by these terms. These terms may be used to distinguish one element from another. For example, a first contact could be termed a second contact, and, similarly, a second contact could be termed a first contact, without departing from the scope of the various described embodiments. The first contact and the second contact are both contacts, but they may not be the same contact.

As used herein, a “machine-learning model” may encompass instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model may be trained using training data, e.g., experiential data and/or samples of input data, which may be fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

In an exemplary use case, a machine learning model may be trained to identify events that might be of interest to a user at the user's departure location during the days of a planned trip to a destination (location) or events at the destination during the days of the planned trip or on alternative days. Based on identifying the events, the machine learning model may recommend a modification to the user's itinerary, such as to move the trip to alternative days, to book an event of interest at the destination, and/or the like. Certain embodiments described herein may interface with various computing systems to help facilitate these modifications prior to completion of the booking of the trip, which may reduce or eliminate consumption of computing resources that would otherwise be consumed modifying the trip at a later time after booking.

While several of the examples above may involve itinerary-related recommendations and/or predictions, it should be understood that techniques according to this disclosure may be adapted to any suitable type of event planning. It should also be understood that the examples above are illustrative only. The techniques and technologies of this disclosure may be adapted to any suitable activity.

Presented below are various aspects of machine learning techniques that may be adapted to generate itinerary-related recommendations and/or predictions for a user. As will be discussed in more detail below, machine learning techniques adapted to evaluate data related to an itinerary, may include one or more aspects according to this disclosure, e.g., a particular selection of training data, a particular training process for the machine-learning model, operation of a particular device suitable for use with the trained machine-learning model, operation of the machine-learning model in conjunction with particular data, modification of such particular data by the machine-learning model, etc., and/or other aspects that may be apparent to one of ordinary skill in the art based on this disclosure.

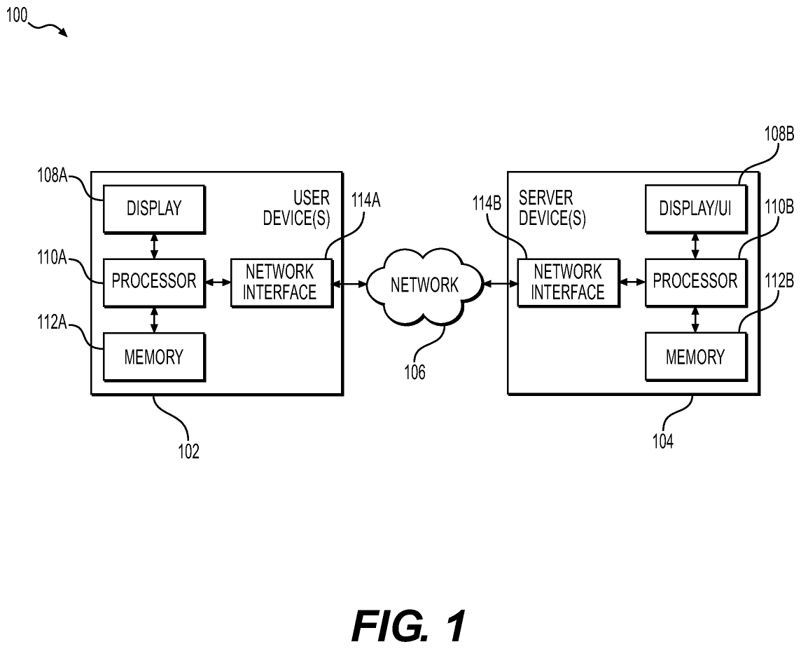

FIG. 1 depicts an exemplary environment 100 for generating itinerary-related recommendations and/or predictions, according to one or more embodiments. The environment 100 may include one or more user devices 102, one or more server devices 104, and a network 106. Although FIG. 1 depicts a single user device 102, server device 104, and network 106, the embodiments described herein are applicable to environments 100 that include two or more user devices 102, server devices 104, and/or networks 106 in any suitable arrangement.

The user device 102 may include a display 108A, a processor 110A, a memory 112A, and/or a network interface 114A. The user device 102 may be a mobile device, such as a smartphone, a cell phone, a tablet, a laptop computer, etc., a desktop computer, and/or the like. The user device 102 may execute, by the processor 110A, one or more instructions stored in the memory 112A to, e.g., generate itinerary-related recommendations and/or predictions, or train and/or use one or more machine learning models to generate the itinerary-related recommendations and/or predictions, as described elsewhere herein. One or more components of the user device 102 may generate, or may cause to be generated, one or more graphic user interfaces (GUIs) based on instructions/information stored in the memory 112A, instructions/information received from the server device 104, and/or the like and may cause the GUIs to be displayed via the display 108A. The GUIs may be, e.g., mobile application interfaces or browser user interfaces and may include text, input text boxes, selection controls, and/or the like. The display 108A may include a touch screen or a display with other input systems (e.g., a mouse, keyboard, etc.) for an operator of the user device 102 to control the functions of the user device 102. The network interface 114A may be a transmission control protocol/Internet protocol (TCP/IP) network interface, or another type of wired or wireless communication interface, for Ethernet or wireless communications with the server device 104 via the network 106.

The server device 104 may include a display 108B, a processor 1106, a memory 112B, and/or a network interface 114B. The server device 104 may be a computer, system of computers (e.g., rack server(s)), or a cloud service computer system (e.g., in a data center). The server device 104 may execute, by the processor 1106, one or more instructions stored in the memory 112B to, e.g., generate itinerary-related recommendations and/or predictions, or train and/or use one or more machine learning models to generate the recommendations and/or predictions, as described elsewhere herein. One or more components of the server device 104 may generate, or may cause to be generated, one or more graphic user interfaces (GUIs) based on instructions/information stored in the memory 1126, instructions/information received from the user device 102, and/or the like and may cause the GUIs to be displayed via the display 108B.

The network 106 may include one or more wired and/or wireless networks, such as the Internet, an intranet, a wide area network (“WAN”), a local area network (“LAN”), a personal area network (“PAN”), a cellular network (e.g., a 3G network, a 4G network, a 5G network, etc.) or the like. The Internet may be a worldwide system of computer networks—a network of networks in which a party at one computer or other device connected to the network can obtain information from any other computer and communicate with parties of other computers or devices. One of the most widely used part of the Internet may be the World Wide Web (often-abbreviated “WWW” or called “the Web”). A “webpage” may encompass a location, data store, or the like that may be, e.g., hosted and/or operated by a computer system so as to be accessible online, and that may include data configured to cause a program such as a web browser to perform operations such as send, receive, or process data, generate a visual display and/or an interactive interface, or the like. The user device 102 and the server device 104 may be connected via the network 106, using one or more standard communication protocols. The user device 102 and the server device 104 may transmit and receive messages from each other across the network 106, as discussed in more detail below.

As discussed in further detail below, the one or more components of exemplary environment 100 may process data from one or more user devices 102 and/or one or more server devices 104. Additionally, or alternatively, and as discussed in further detail below, the one or more components of exemplary environment 100 may generate, store, train and/or use a machine-learning model for generating itinerary-related recommendations and/or predictions. The exemplary environment 100 or one of its components may include or be in operable communication with a machine-learning model and/or instructions associated with the machine-learning model, e.g., instructions for generating a machine-learning model, training the machine-learning model, using the machine-learning model, etc. The exemplary environment 100 or one of its components may include instructions for retrieving data, adjusting data, e.g., based on the output of the machine-learning model, and/or operating a display to output data, e.g., as adjusted based on the machine-learning model. The exemplary environment 100 or one of its components may include, provide, obtain, and/or generate training data.

In some embodiments, a system or device other than the components shown in the exemplary environment 100 may be used to generate and/or train the machine-learning model. For example, such a system may include instructions for generating and/or obtaining the machine-learning model, the training data and ground truth, and/or instructions for training the machine-learning model. A resulting trained-machine-learning model may then be provided to the exemplary environment 100 or one of its components and, for example, stored in the memory 112A and/or 112B.

A machine-learning model may include a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable. Certain embodiments may utilize, for training a machine learning model, unsupervised learning where, e.g., the sample of training data may not include pre-assigned labels or scores to aid the learning process or may utilize semi-supervised learning where a combination of training data with pre-assigned labels or scores and training data without pre-assigned labels or scores is used to train a machine learning model.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., may be used to compare the output of the trained model with the ground truth for that portion of the training data to evaluate an accuracy of the trained model. The training of the machine-learning model may be configured to cause the machine-learning model to learn associations between training data (e.g., computing system data) and ground truth data, such that the trained machine-learning model is configured to determine an output in response to the input data based on the learned associations.

In various embodiments, the variables of a machine-learning model may be interrelated in any suitable arrangement in order to generate the output. For example, in some embodiments, the machine-learning model may include an architecture that is configured to determine a relevance score for data from a computing system based on values (e.g., historical or predicted values) for one or more target variables for the data (e.g., determine a score that indicates a likelihood of an event being of interest to an individual). For example, the machine-learning model may include one or more neural networks configured to identify features in the data, and may include further architecture, e.g., a connected layer, neural network, etc., configured to determine a relationship between the identified features in order to determine a location in the data. In certain embodiments, the machine learning model may include a single node for classification, as described elsewhere herein.

In some instances, different samples of training data and/or input data may not be independent. Thus, in some embodiments, the machine-learning model may be configured to account for and/or determine relationships between multiple samples.

For example, in some embodiments, the machine-learning model of certain embodiments may include a Recurrent Neural Network (“RNN”). Generally, RNNs are a class of feed-forward neural networks that may be well adapted to processing a sequence of inputs. In some embodiments, the machine-learning model may include a Long Short-Term Memory (“LSTM”) model and/or Sequence to Sequence (“Seq2Seq”) model. An LSTM model may be configured to generate an output from a sample that takes at least some previous samples and/or outputs into account.

Although depicted as separate components in FIG. 1, it should be understood that a component or portion of a component in the exemplary environment 100 may, in some embodiments, be integrated with or incorporated into one or more other components. For example, the server device 104 may be integrated in a data storage system. In some embodiments, operations or aspects of one or more of the components discussed above may be distributed amongst one or more other components. Any suitable arrangement and/or integration of the various systems and devices of the exemplary environment 100 may be used.

Further aspects of itinerary-related recommendations and/or predictions or of the machine-learning model and/or how it may be trained or used to generate the recommendations and/or predictions are discussed in further detail below. In the following disclosure, various acts may be described as performed or executed by a component from FIG. 1, such as the user device 102, the server device 104, or components thereof. However, it should be understood that in various embodiments, various components of the exemplary environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

The example environment 100 described above is provided merely as an example, and may include additional, fewer, different, or differently arranged aspects than depicted in FIG. 1.

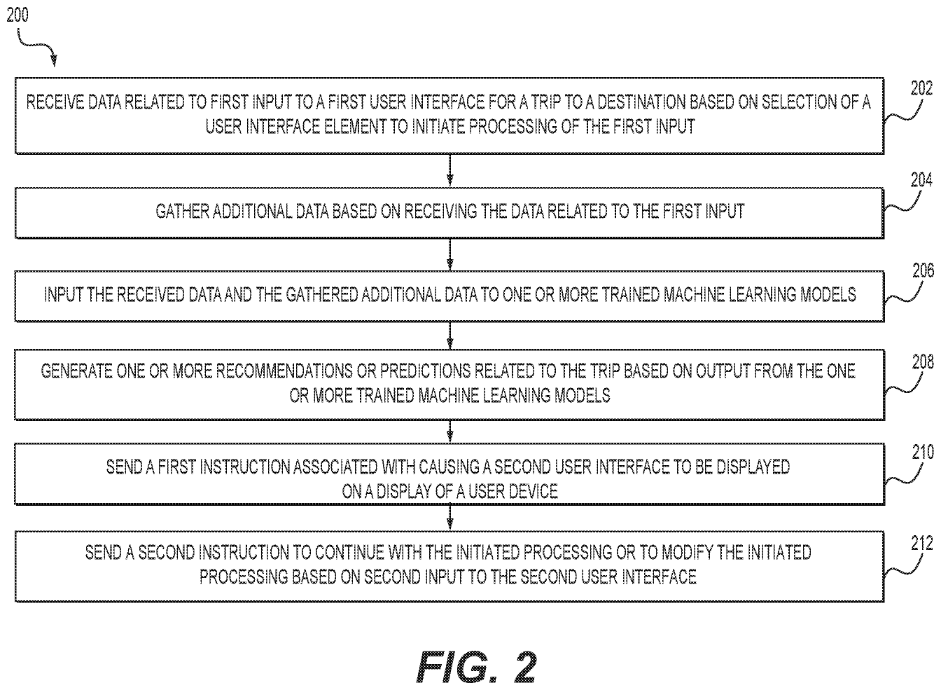

FIG. 2 depicts a flowchart of an exemplary method 200 of generating itinerary-related recommendations and/or predictions for a user, according to one or more embodiments. In some embodiments, the method 200 may be performed by a server device 104. In other embodiments, the method 200 may be performed by the user device 102 (e.g., an application or browser extension installed on the user device 102).

At step 202, the method 200 may include receiving data related to first input to a first user interface for a trip to a destination based on selection of a user interface element to initiate processing of the first input. For example, the server device 104 may receive data related to the first input based on a user of the user device 102 selecting the user interface element. In certain embodiments, the server device 104 may receive the data related to the first input from a module (e.g., a browser extension installed on a web browser installed on the user device 102) or an application installed on the user device 102. As examples of the first input, a user of the user device 102 may input dates for a trip into a user interface on a web browser or application, may select a transportation option (e.g., flights) for the trip on the user interface, and/or the like. The first input may include, e.g., text in a text box, selection of a menu item, a voice command, and/or the like. The first user interface may include a user interface that a user uses to book a trip, such as a webpage or application user interface used for searching and/or viewing transportation options to a destination, lodging options at the destination, and/or the like. A user interface element may include a button, a text box, a menu, an image, text, and/or the like associated with a user interface.

The server device 104 may receive the data related to the first input based on the user selecting a user interface element of the user interface. For example, after the user of the user device 102 inputs the first input to the user interface, the user may select a button or other control (e.g., a “search” button, a “complete booking” button, etc.) to submit the first input to one or more computing devices (e.g., the server device 104) for processing, and the user device 102 may provide the data related to the first input to the server device 104 based on this selection. As a specific example in the context of booking a trip to a destination, the user may input dates for the trip, a desired departure time, a destination city, and/or the like, and may select a button to search for flights or to complete purchase of a flight. In this specific example, the server device 104 may receive the data related to the first input when the user selects the button to search for the flights or to complete purchase of the flight. The server device 104 may receive the data at step 202 from one or more computing systems, such as a travel service-related system (e.g., for transportation and/or lodging booking), a reservation-related system (e.g., for dining or entertainment reservations), and/or the like.

As explained above, the server device 104 may receive the data related to the first input based on user selection of a user interface element to initiate processing. For example, the selection of the user interface element may initiate a search based on the first input, may initiate completion of a purchase or reservation based on the first input, and/or the like.

In certain embodiments, the server device 104 may receive the data related to the first input automatically after the user selects the user interface element, after the user device 102 and/or another server device 104 (e.g., a web server device) performs processing on the data (e.g., to anonymize the data or filter out data that the server device 104 does not need for generating recommendations and/or predictions), and/or the like.

The data related to the first input may include data elements (or a subset of data elements) of the first input (e.g., text of dates, destination, etc.), a conversion of the first input to another form of data (e.g., conversion of menu selections to text data), and/or the like. Additionally, or alternatively, the data related to the first input may identify the user of the user device 102, may include metadata related to the first input (e.g., a time or date of when the user input the first input), alternative dates, destinations, or modes of transportation for which the user searched, and/or the like.

The method 200 may include, at step 204, gathering additional data based on receiving the data related to the first input. For example, the server device 104 may gather the additional data based on receiving the data related to the first input. The server device 104 may gather the additional data automatically after receiving the data related to the first input, based on receiving a command to gather the additional data (e.g., from the user of the user device 102 or from another user device 102), at a scheduled time after receiving the data related to the first input, and/or the like.

In some embodiments, the server device 104 may receive the additional data from one or more computing systems (e.g., a dining service-related system for searching and/or making dining reservations, an entertainment service-related system for searching and/or making entertainment reservations or purchases, and/or the like). Additionally, or alternatively, the server device 104 may receive the additional data from a profile or an account associated with the user of the user device 102 (e.g., may receive user preferences from a user profile, may receive previous transaction data from a financial account, etc.). Additionally, or alternatively, the server device 104 may receive the additional data from a webpage. For example, the server device 104 may use a web crawler, computer vision, and/or image processing to process one or more webpages and gather data contained on the webpages. Additionally, or alternatively, the server device 104 may, based on permission provided by the user, use a web crawler to process an email account or another type of account to identify offers or events that might be of interest to the user at a destination or at a home location. For example, the user may subscribe to an email listserv of events at their home location or at a destination, and the server device 104 may process emails from the listserv to identify events of interest.

The additional data may include user preferences (e.g., related to cost limits, activity preferences or interests, etc.). Additionally, or alternatively, the additional data may include transaction data related to prior purchases of the user or other individuals (e.g., other individuals who have traveled to the same destination), which may identify types of activities previously purchased and/or sub-classifications of each activity, a cost of the previously purchased activities, characteristics of the previously purchased activities, and/or the like. For example, sub-classifications for a dining activity may include customer review rating, type of cuisine, etc., sub-classes for an entertainment activity may include type of activity (e.g., sporting event, concert, or movie), genre of the activity (e.g., action or drama for a movie, rock or classical for a concert, etc.), and/or the like.

Additionally, or alternatively, the additional data may include data gathered from webpages related to preferences, interests, etc. of the user. For example, if the user has indicated a preference for, or interest in, sporting events, then the additional data may include data gathered from webpages that provide details on sporting events at the destination during the dates of the trip or at the user's home location during the dates of the trip. Certain embodiments may use a web crawler to gather the additional data while the user is offline or may use computer vision to gather the additional data from webpages while the user is browsing the webpages (e.g., a browser extension on a web browser that the user is using may gather the additional data).

The additional data may include data related to prior activities of the user or one or more other users. For example, the additional data may include data related to prior trips that the user or other users have taken, prior events at a destination or the user's home location that the user or the other users have attended, prior spending patterns of the user or other users at the destination or the user's home location (e.g., spending amounts on dining, entertainment, etc.), and/or the like.

The following is an example of step 204. The server device 104 may receive first input that identifies that the user is booking a trip from location A to location B for a date range. Based on this, the server device 104 may determine that the user has a preference for sporting events (e.g., based on the user's web browsing history and/or past transaction history). The server device 104 may then gather additional data from a webpage related to sporting events at location A or location B, such as a listing of teams playing, times of the events, costs of tickets to the events, and/or the like. For the destination location B, the server device 104 may also gather additional data related to sporting events on other date ranges. In this way, the server device 104 may gather additional data related to activities that might be of interest to the user, either at the departure location or the destination.

At step 206, the method 200 may include inputting the received data and the gathered additional data to one or more trained machine learning models. For example, the server device 104 may input the data received at step 202 and the additional data gathered at step 204 to one or more trained machine learning models. The server device 104 may input the received data and the gathered additional data at a same time, in order of receipt, based on receiving a command to input the data, after the receiving and the gathering, and/or the like.

The one or more trained machine learning models may have been trained to receive an input of the data related to the first input and the gathered additional data and output one or more characteristics of the destination, one or more characteristics of an activity of interest identified in the gathered additional data, a score that indicates a likelihood of a user's interest in an activity, and/or the like. For example, the one or more characteristics of the destination may include size of the destination (e.g., small town, mid-size city, large city, etc.), environment of the destination (e.g., warm climate, winter weather, beach destination, etc.), popular types of attractions at the destination (e.g., nightlife, dining, adventure sports, etc.), and/or the like. As another example, the one or more characteristics of an activity of interest may include a specific type of activity (e.g., dining, concert, sporting event, etc.), a price range of the activity (e.g., high, medium, or low), a popularity of the activity for at the destination or at the departure location, and/or the like.

Certain embodiments may include different machine learning models for different recommendations and/or predictions that the server device 104 may generate. For example, the server device 104 may host or be in communication with a destination model that may generate recommendations and/or predictions based on the destination for the trip. Additionally, or alternatively, and as another example, the server device 104 may host or be in communication with an events of interest model that may identify events that the user might be interested at the destination during the dates of the trip or during alternative dates and/or at the user's origin location during the dates of the trip or during alternative dates. Additionally, or alternatively, and as another example, the server device 104 may host or be in communication with a prior purchases model that may use the user's prior transaction history and/or the prior transaction history of other individuals who have traveled to the destination to generate recommendations and/or predictions for activities that the user might be interested in at the destination, price points for the activities, and/or the like. Additionally, or alternatively, and as another example, the server device 104 may host or be in communication with a cost prediction model that may generate a prediction of a total cost for the trip based on other similar individuals' spending at the destination for a similar length trip, based on the activities that the user may be interested in and/or may engage in based on prior transaction history, and/or the like.

At step 208, the method 200 may include generating one or more recommendations or predictions related to the trip based on output from the one or more trained machine learning models. For example, the server device 104 may generate one or more recommendations or predictions related to the trip based on output from the one or more trained machine learning models. The server device 104 may generate the one or more recommendations or predictions after the one or more trained machine learning models provide the output at step 206, based on receiving a command to generate the one or more recommendations or predictions, at a scheduled time after the one or more trained machine learning models provide the output, and/or the like.

The server device 104 may generate the one or more recommendations or predictions based on one or more rules. For example, certain output from the one or more trained machine learning models may trigger the server device 104 to generate the one or more recommendations or predictions as defined by a pre-defined rule. As a specific example, the server device 104 may recommend add-on purchases to a destination by default, such a recommendation to book a hotel for a multi-day trip, to book a rental car for a booked flight, to reserve a restaurant with a threshold popularity for the destination, and/or the like.

Additionally, or alternatively, the server device 104 may generate the one or more recommendations or predictions based on inputting the output from the one or more trained machine learning models to one or more other trained machine learning models. For example, the one or more other trained machine learning models may determine a likelihood of a user's interest in an activity at the destination or at a departure location, may determine whether the activity at the destination coincides with the travel dates for the trip or whether the activity at the departure location conflicts with the travel dates, and may generate a recommendation to modify the travel dates of the trip to coincide with the activity at the destination or to not conflict with the activity at the departure location.

The recommendations and/or predictions may include, e.g., a recommendation of an alternative destination, an alternative location, and/or an alternative itinerary. For example, the server device 104 may generate alternative destinations or alternative itineraries that are cheaper, that are similar to the destination (e.g., in terms of climate, region of a country, available activities, etc.), that better match user preferences (e.g., explicit preferences in a profile or implicit preferences determined from past travel and/or transaction data), and/or the like. Additionally, or alternatively, and as another example, the recommendations and/or predictions may include a recommendation of activities of interest at the destination. For example, the server device 104 may generate a list of activities at the destination that the user might be interested in based on preferences of the user, prior transaction data that indicates the types of activities that the user has previously engaged in, activities of other individuals who have traveled to the same destination, and/or the like.

Additionally, or alternatively, and as another example, the recommendations and/or predictions may include a recommendation of alternative travel dates for the trip. For example, the server device 104 may generate a recommendation of alternative travel dates for the trip based on the alternative dates being associated with lower costs for the trip, based on the alternative dates covering an event at the destination that the user might be interested in, based on the alternative dates avoiding a conflict with an event of interest at the user's home location, and/or the like. Additionally, or alternatively, and as another example, the recommendations and/or predictions may include a recommendation for add-on purchases for the trip. For example, the server device 104 may generate a recommendation of additional purchases related to the trip and/or the destination based on add-on purchases for other trips by the user or other individuals (e.g., when the user is booking a flight, the server device 104 may recommend booking a hotel or a short-term rental, ground transportation at the destination, and/or the like). Additionally, or alternatively, and as another example, the recommendations and/or predictions may include a prediction of a total cost of a trip or sub-categories of costs of the trip (e.g., costs of transportation, lodging, dining, entertainment, attractions, insurance, etc.).

In some embodiments, the server device 104 may generate the one or more recommendations and/or predictions based on data from a system related to determining travel times, security wait times (e.g., wait times for airport security), traffic data, and/or the like. For example, the server device 104 may recommend scheduling an earlier or later flight based on travel times and the scheduled time for an event at the destination in order to reduce the likelihood of arriving late to the event.

The method 200 may include, at step 210, sending a first instruction associated with causing a second user interface to be displayed on a display of a user device. For example, the server device 104 may send a first instruction associated with causing a second user interface to be displayed on a display of the user device 102 (e.g., a webpage or an application user interface to be populated with a hyperlink or selectable user interface element). The server device 104 may send the first instruction after generating the one or more recommendations or predictions, based on receiving a command from a user of the server device 104, and/or the like. The first instruction may include a message, command, or signal, such as a hypertext transfer protocol (HTTP) response, a serverlet response, and/or the like.

The second user interface may be displayed on a pop-up window, a webpage, a push notification, a text message, an email, and/or the like. The second user interface may include the one or more recommendations or predictions related to the trip, characteristics of the destination or the activity that caused the one or more recommendations or predictions to be generated, and/or the like. The second user interface may include one or more controls related to modifying the trip and/or continuing with the initiated processing. For example, and for modifying the trip, the second user interface may include one or more controls to change dates for the trip, to change a destination for the trip, to add one or more add-on purchases or activities to the trip, and/or the like. As an example related to continuing with the initiated processing, the second user interface may include one or more controls to ignore the recommendations or predictions, to complete a booking or a purchase for the trip, and/or the like.

At step 212, the method 200 may include sending a second instruction to continue with the initiated processing or to modify the initiated processing based on second input to the second user interface. For example, the server device 104 may send a second instruction to continue with the initiated processing or to modify the initiated processing based on second input to the second user interface. The server device 104 may send the second instruction after sending the first instruction and after receiving the second input, based on receiving a command to send the second instruction, at a scheduled time after sending the first instruction, and/or the like. The second instruction may include a message, command, or signal, such as an HTTP response, a serverlet response, and/or the like.

Continuing with the initiated processing may include completing a booking for the trip, completing a purchase for the trip, and/or the like (e.g., without modifying the first input to the first user interface). For example, the server device 104 may send the second instruction to a transaction server device to complete a purchase, a booking server device to complete a reservation, to a web server device to send the first input to the transaction server device or the booking server device or to update a webpage regarding completion of the purchase or the reservation, to the application installed on the user device 102 to complete a purchase or a reservation, and/or the like.

Modifying the initiated processing may include modifying the date range for the trip, modifying the destination, modifying a combination of purchases for the trip, modifying a mode of transportation to the destination, and/or the like. For example, the second input may include an indication that the user would like to accept the recommendation from the server device 104 to attend a concert at the user's departure location and the server device 104 may determine to modify the date range for the trip to not conflict with the concert. Continuing with the previous example, the server device 104 may shift the date range to an earlier date range or a later date range and may provide the updated date range to the display for confirmation by the user. If the user accepts the modified date range, or inputs a new date range, the server device 104 may send an instruction to continue with the initiated process according to the modified date range.

The example method 200 described above is provided merely as an example, and may include additional, fewer, different, or differently arranged aspects than depicted in FIG. 2.

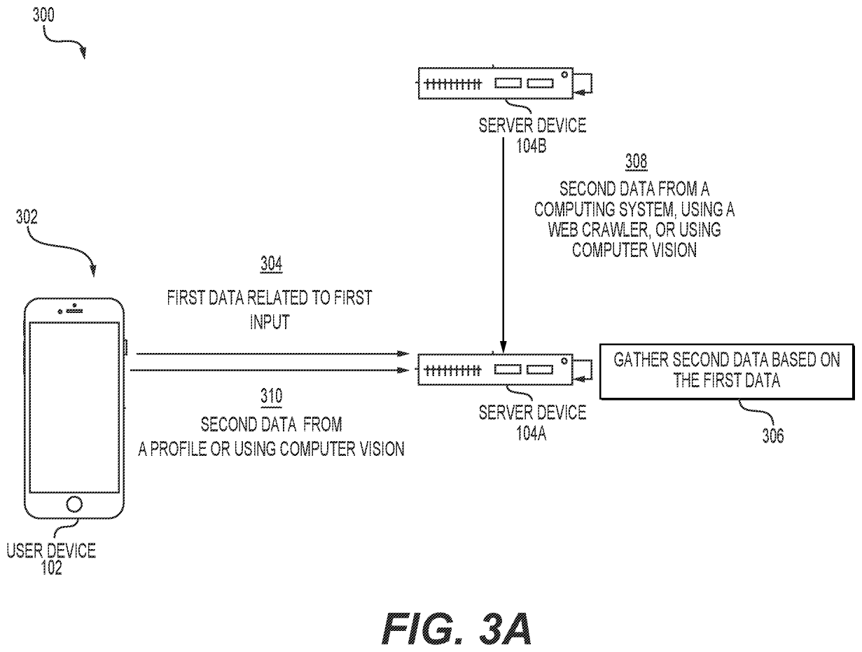

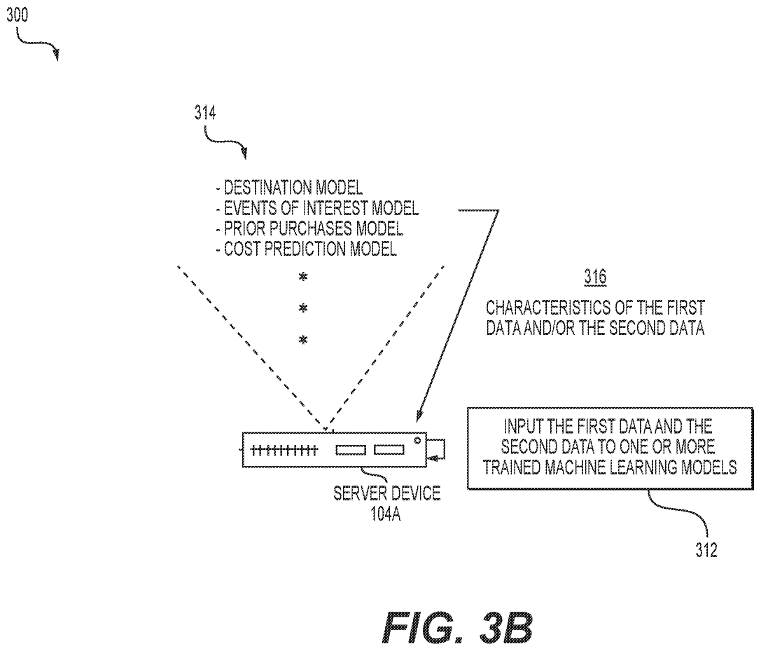

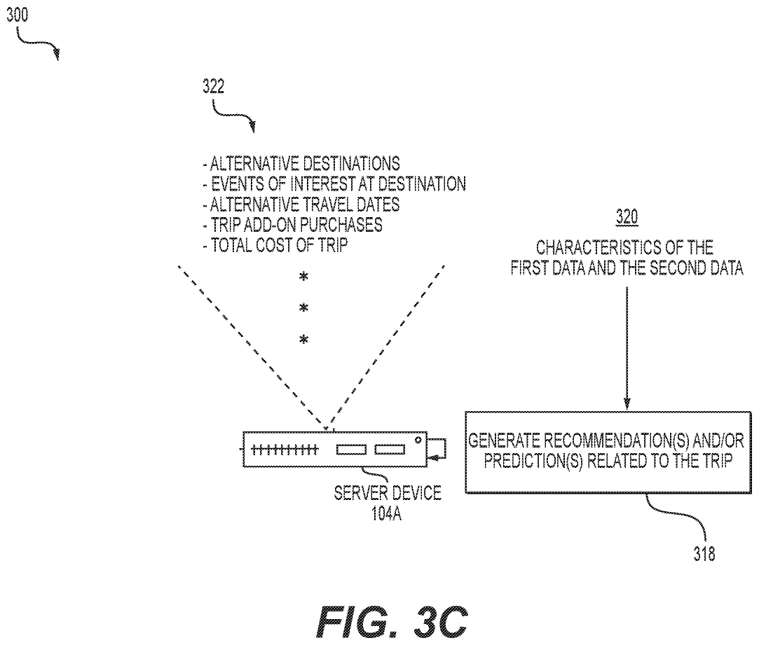

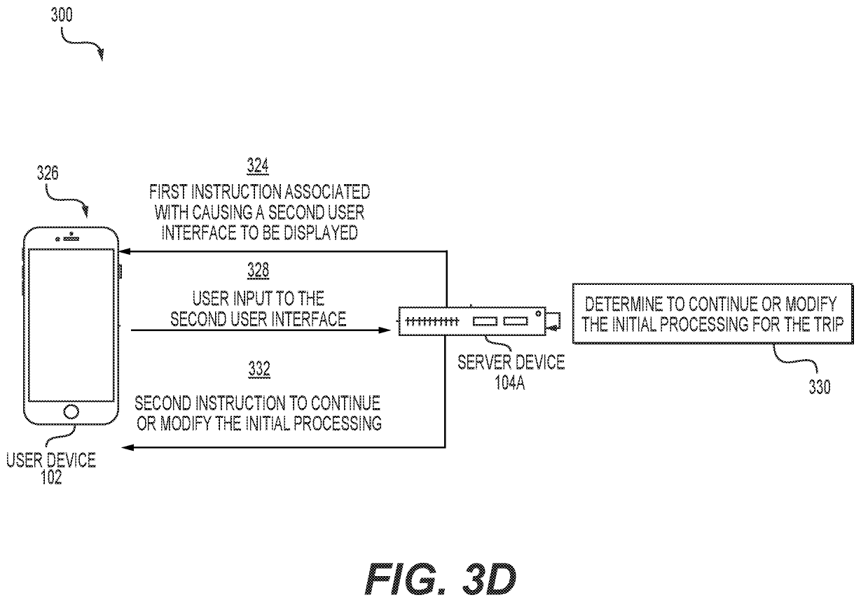

FIGS. 3A-3D depict an example 300 of generating itinerary-related recommendations and/or predictions for a user, according to one or more embodiments. As illustrated in FIG. 3A, the example 300 may include a user device 102, a server device 104A, and a server device 1046. As illustrated at 302, a user of the user device 102 may input first input to a user interface provided for display via the user device 102. For example, the user may input a date range for a trip, a destination for the trip, a mode of transportation for traveling to the destination, and/or the like as the first input.

At 304, the user device 102 may provide, and the server device 104A may receive, first data related to the first input for the trip to the destination. For example, the server device 104A may receive the first data in a manner similar to that described above with respect to step 202 of FIG. 2. The example 300 may include, at 306, the server device 104A gathering second data based on the first data, e.g., in a manner similar to that described at step 204 of FIG. 2. For example, and as illustrated at 308, the server device 104A may gather the second data from a computing system (e.g., server device 104B of a computing system for making dining, entertainment, etc. reservations), using a web crawler (e.g., from server device 104B hosting a webpage), or using computer vision (e.g., to gather text or images from a webpage). As another example, and as illustrated at 310, the server device 104A may gather the second data from a profile (e.g., from profile information stored in an application or a database associated with the profile) or using computer vision (e.g., to gather data input to a user interface and information identifying the elements into which the data was input). Additionally, or alternatively, and as additional examples, the server device 104A may gather data from an email account, an electronic calendar, and/or the like to identify conflicting events for a trip.

Turning to FIG. 3B, and as illustrated at 312, the example 300 may include inputting the first data and the second data to one or more trained machine learning models, e.g., in a manner similar to that described at 206 of FIG. 2. For example, and as illustrated at 314, the one or more trained machine learning models may include a destination model trained for destinations, an events of interest model trained for events, a prior purchases model trained for prior purchases, a cost prediction model trained for predicting trip costs, and/or the like. The one or more trained machine learning models may, at 316, output characteristics of the first data and/or the second data, e.g., in a manner similar to that described elsewhere herein.

Turning to FIG. 3C, and as illustrated at 318, the server device 104A may generate recommendation(s) and/or prediction(s) related to the trip. For example, the server device 104A may generate the recommendation(s) and/or the prediction(s) in a manner similar to that described at step 208 of FIG. 2. As illustrated at 320, the server device 104A may utilize the characteristics of the first data and the second data to generate the recommendation(s) and/or the prediction(s). As described elsewhere herein, the server device 104A may generate the recommendation(s) and/or the predictions using one or more rules, one or more other trained machine learning models, and/or the like. As illustrated at 322, the recommendation(s) and/or predictions may include one or more alternative destinations, one or more events of interest at a destination, one or more alternative travel dates for a trip, one or more trip add-on purchases, a total cost of the trip, and/or the like.

Turning to FIG. 3D, and as illustrated at 324, the server device 104A may provide a first instruction associated with causing a second user interface to be displayed, e.g., in a manner similar to that described above with respect to FIG. 2. For example, the user interface may include a pop-up window that includes the recommendation(s) and/or prediction(s). As illustrated at 326, a user of the user device may provide user input to the second user interface. For example, the user may input an indication to modify the trip based on the recommendation(s) and/or prediction(s) or to ignore the recommendation(s) and/or predictions(s) and continue with the trip as planned.

As illustrated at 328, the user device 102 may send, and the server device 104A may receive, the user input to the second user interface, e.g., in a manner similar to that described elsewhere herein. As illustrated at 330, the server device 104A may determine to continue or modify the initial processing for the trip. For example, the server device 104A may determine to continue with the initial process of booking and/or making a purchase related to the trip if the user input indicates to ignore the recommendation(s) and/or prediction(s) from the server device 104A. Alternatively, the server device 104A may determine to modify the initial process for booking and/or making the purchase based on the user input indicating to change aspects related to the trip. The example 300 may include, at 332, providing a second instruction to continue or modify the initial processing, e.g., in a manner similar to that described at 212 of FIG. 2.

The example 300 described above is provided merely as an example, and may include additional, fewer, different, or differently arranged aspects than depicted in FIGS. 3A-3D.

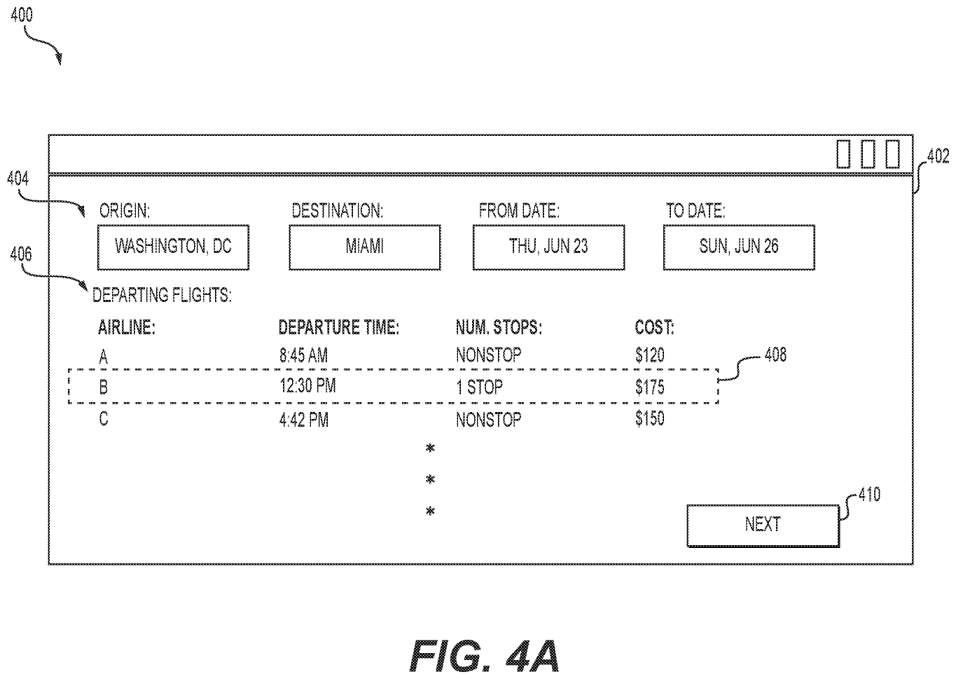

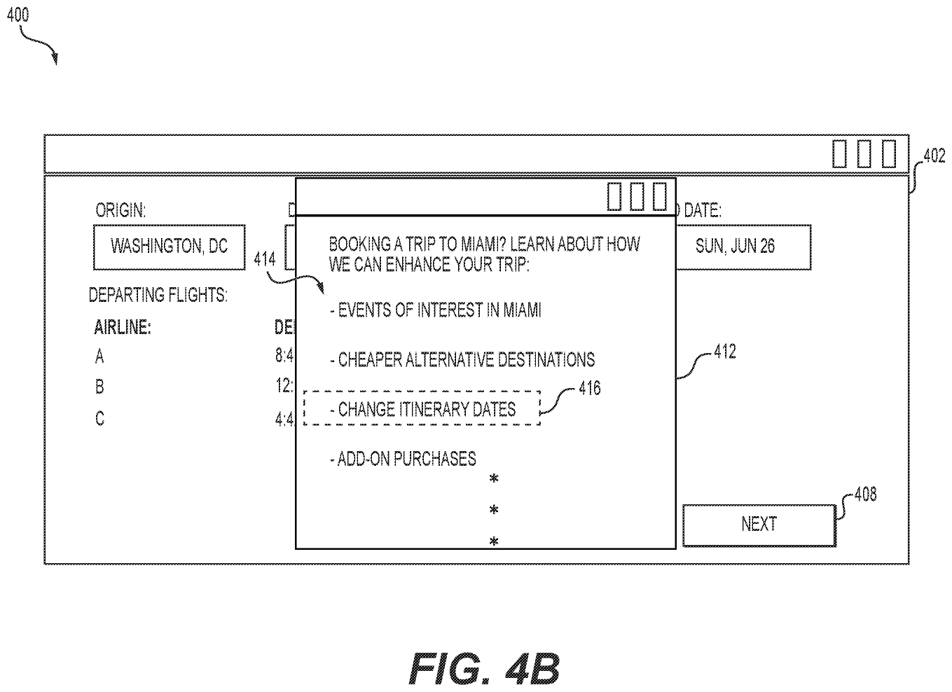

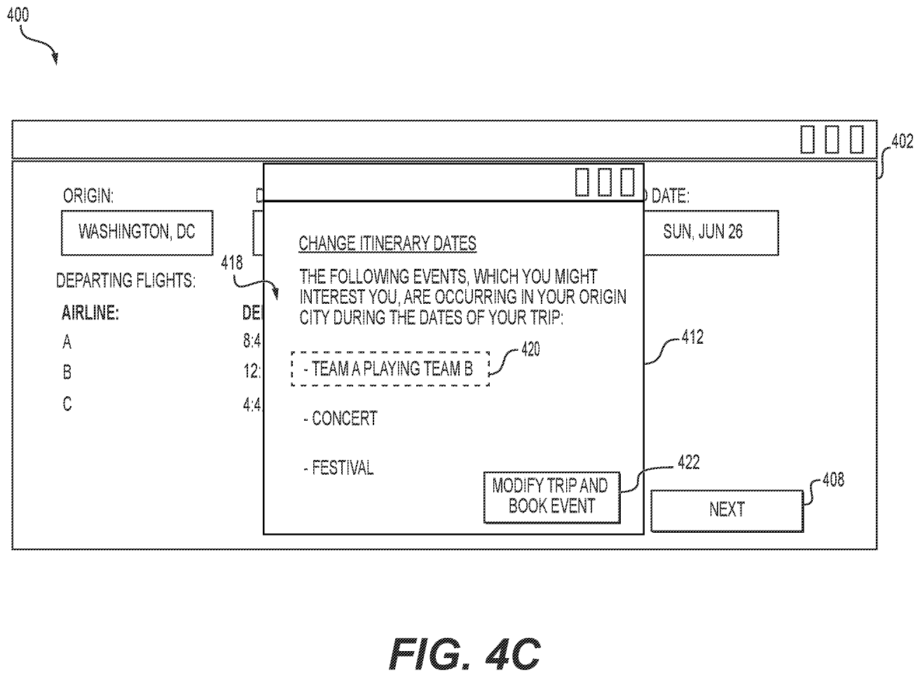

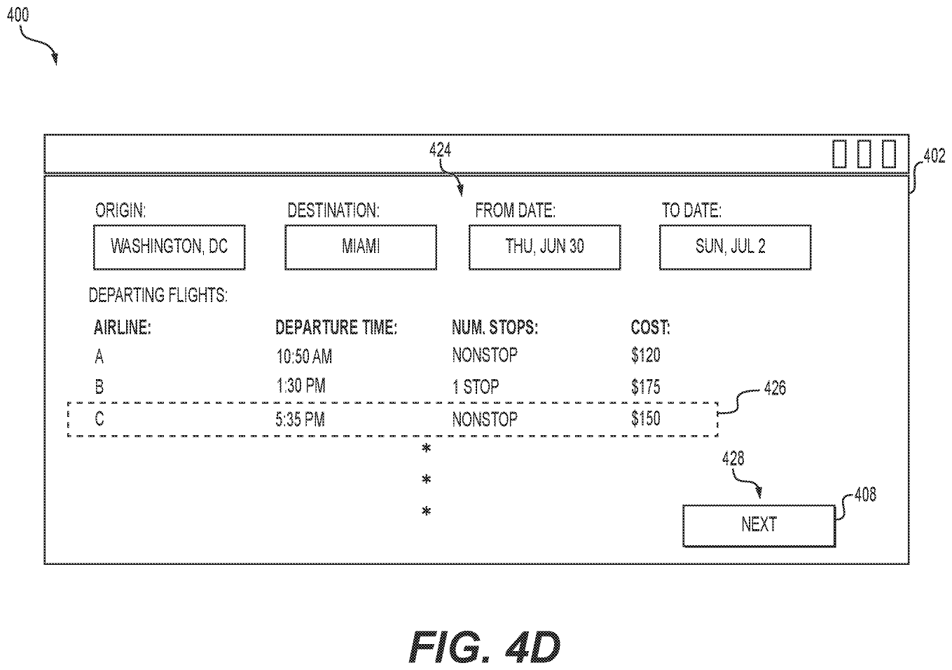

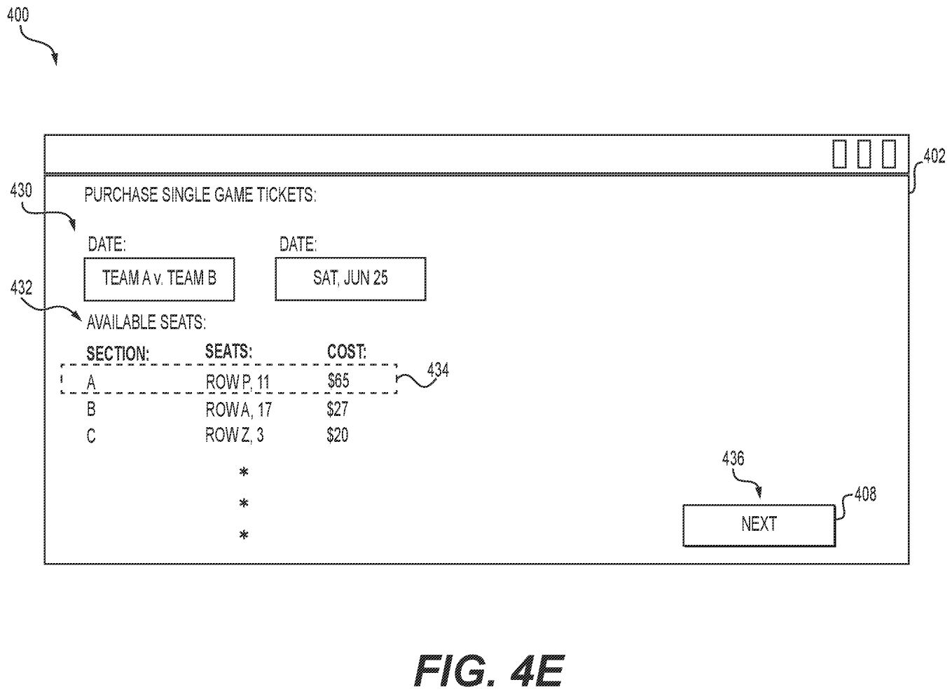

FIGS. 4A-4E depict an example 400 of user interface operations related to generating itinerary-related recommendations and/or predictions for a user, according to one or more embodiments. FIGS. 4A-4E illustrate example operations of a user interface displayed on a user device 102, according to one or more embodiments. Although the example 400 is described in context of booking a flight to a destination, certain embodiments of the example 400 may apply to other contexts.

The example 400 may include a web browser 402, as illustrated in FIG. 4A. The web browser 402 may display a user interface that includes various user interface elements. For example, the user interface may include text, text boxes, selection menus, buttons, and/or the like. As illustrated at 404, the user interface may include text and text boxes for inputting information for a trip, e.g., an origin city, a destination city, and a date range for the trip. The user interface may include, at 406, text and/or a selection menu for departing flights from the origin city to the destination city on the departure date. As illustrated at 408, the user may select one of the available flights from the selection menu illustrated at 406. As illustrated at 410, the user interface may include a “NEXT” button to advance from the user interface to another user interface (e.g., associated with a subsequent step of a process for booking a trip to the destination city, such as selecting a returning flight or for completing a purchase of a ticket for the selected flight).

Turning to FIG. 4B, based on user selection of the button at 410 in FIG. 4A, a pop-up window 412 that displays another user interface may be provided for display on the user device 102. As illustrated at 414, the other user interface may include hyperlinks or user interface controls to view or access recommendation(s) and/or prediction(s) from a server device 104 (e.g., recommendation(s) and/or prediction(s). For example, the pop-up window 412 may include information related to events that might be of interest to the user of the user device 102, alternative destinations to the original destination, such as cheaper destinations, recommendation(s) for changing itinerary dates, such as to avoid conflicts with events at the origin city, recommendation(s) for add-on purchases for the trip, such as lodging or dining reservations, and/or the like. As another example, the server device 104 may populate the pop-up window 412 with a hyperlink or button associated with causing the information related to the events of interest to be displayed. In the example 400, the user of the user device 102 may select, e.g., to view recommendation(s) for changing itinerary dates, as illustrated at 416.

Turning to FIG. 4C, based on the user selection at 418 of FIG. 4B, the pop-up window 412 may display events, which might be of interest to the user, at the origin city during the planned trip dates. For example, the server device 104A may have identified a sporting event (“team A playing team B”), a concert, and a festival as matching events that might be interest to the user. As illustrated at 420, the user may select, e.g., the sporting event as an event to attend. The user may then select, at 422, a button to modify the trip and book the event selected at 420. In scenarios where the user decides to not modify the trip, the user may just close the pop-up window 412.

Turning to FIG. 4D, the web browser 402 may display flights for an updated departure date based on the server device 104 modifying the trip dates to not conflict with the selected sporting event, as illustrated at 424. The user may select, e.g., one of the displayed flights for the trip, as illustrated at 426. Then, as illustrated at 428, the user may select a “Next” button to proceed to a subsequent stage of the process, such as selecting a returning flight, purchasing the flight tickets, selecting tickets for the sporting event, and/or the like.

Turning to FIG. 4E, the web browser 402 may display a user interface related to purchasing tickets to the sporting event. For example, and as illustrated at 430, the user interface may include information that identifies the sporting event and/or the date of the event. As another example, and as illustrated at 432, the user interface may display information related to available tickets for the sporting event. The user may select one of the tickets for purchase, as illustrated at 434. The user may select the “Next” button illustrated at 436 to proceed with purchasing the ticket.

The example 400 described above is provided merely as an example, and may include additional, fewer, different, or differently arranged aspects than depicted in FIGS. 4A-4E.

In this way, certain embodiments may process data related to a trip for a user to understand the context or characteristics of the trip, preferences of the user, and/or prior purchases of the user. Certain embodiments may then recommend additional purchases, additional reservations, modifications to the trip, and/or the like based on the context or characteristics. This may help to reduce or eliminate a need for the user to search for such additional purchases or reservations and/or to make the modifications at a later time, which may conserve computing resources of computers, telephones, etc. that would otherwise be used for those purposes. In addition, certain embodiments may provide a centralized system for making the additional purchases, additional reservations, and/or the modifications, which may increase an efficiency of these activities and/or increase a security of these activities, e.g., by reducing or eliminating a need for the user to provide transaction account/card information to various different computing systems. Furthermore, certain embodiments may improve a customer experience or satisfaction with respect to planning a trip to a destination.

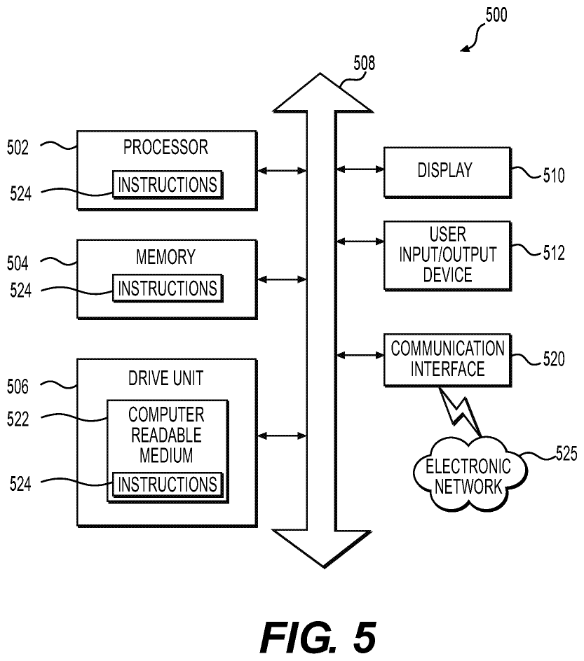

FIG. 5 depicts an example of a computer 500, according to certain embodiments. FIG. 5 is a simplified functional block diagram of a computer 500 that may be configured as a device for executing processes or operations depicted in, or described with respect to, FIGS. 1-4E, according to exemplary embodiments of the present disclosure. For example, the computer 500 may be configured as the user device 102, server device 104, and/or another device according to exemplary embodiments of this disclosure. In various embodiments, any of the systems herein may be a computer 500 (or include multiple computers 500) including, e.g., a data communication interface 520 for packet data communication. The computer 500 may communicate with one or more other computers 500 using the electronic network 525. The network interfaces 114A, B in FIG. 1 may include one or more communication interfaces 520. The electronic network 525 may include a wired or wireless network similar to the network 106 depicted in FIG. 1.

The computer 500 also may include a central processing unit (“CPU”), in the form of one or more processors 502, for executing program instructions 524. The processors 110A, B depicted in FIG. 1 may include one or more processors 502. The computer 500 may include an internal communication bus 508, and a drive unit 506 (such as read-only memory (ROM), hard disk drive (HDD), solid-state disk drive (SDD), etc.) that may store data on a computer readable medium 522, although the computer 500 may receive programming and data via network communications. The computer 500 may also have a memory 504 (such as random access memory (RAM)) storing instructions 524 for executing techniques presented herein, although the instructions 524 may be stored temporarily or permanently within other modules of the computer 500 (e.g., processor 502 and/or computer readable medium 522). The memories 112A, B depicted in FIG. 1 may include one or more memories 504. The computer 500 also may include user input and output ports 512 and/or a display 510 to connect with input and output devices such as keyboards, mice, touchscreens, monitors, displays, etc. The displays 108A, B may include one or more displays 510. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, e.g., may enable loading of the software from one computer or processor into another, e.g., from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to processing data related to a trip, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be understood that embodiments in this disclosure are exemplary only, and that other embodiments may include various combinations of features from other embodiments, as well as additional or fewer features. For example, while some of the embodiments above pertain to processing data related to a trip using a machine learning model, any suitable activity may be used. In an exemplary embodiment, instead of or in addition to processing data related to a trip, certain embodiments may include processing data related to planning any event and/or related to services.

It should be appreciated that in the above description of exemplary embodiments of the invention, various features of the invention may sometimes be grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects may lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for activity-related output, comprising:
receiving, by a server device and from a module or an application installed on a user device of an individual, data related to first input to a first user interface for an activity associated with a location based on a selection of a user interface element to initiate processing of the first input;
gathering additional data based on receiving the data related to the first input,
the additional data comprising one or more prior activities of the individual gathered from one or more computing systems, the additional data further comprising one or more activities of interest to the individual gathered from the one or more computing systems, gathered from a profile of the individual, gathered using a web crawler, or gathered using computer vision;
inputting the received data and the gathered additional data to one or more trained machine learning models,
first output from the one or more trained machine learning models, the first output comprising one or more characteristics of the location or one or more characteristics of the one or more activities of interest;
generating, based on the first output from the one or more trained machine learning models, second output related to the activity, the second output comprising:
one or more alternative locations, or
one or more activities for the individual at the location;
sending a first instruction associated with causing a second user interface to be displayed on a display of the user device, the second user interface comprising the second output; and
sending, based on second input to the second user interface, a second instruction to modify the initiated processing.

2. The computer-implemented method of claim 1, wherein the additional data further comprises:
one or more prior activities of one or more other individuals at the location.

3. The computer-implemented method of claim 2, wherein the first output from the one or more trained machine learning models further comprises:
amounts of the one or more prior activities of the individual or the one or more prior activities of the one or more other individuals, or
one or more characteristics of the one or more prior activities of the individual or the one or more prior activities of the one or more other individuals.

4. The computer-implemented method of claim 3, wherein the second output further comprises:
a total cost associated with the location, or
one or more additional activities related to the location.

5. The computer-implemented method of claim 1, wherein the generating of the second output further comprises:
generating the second output using one or more other trained machine learning models or using one or more pre-defined rules.

6. The computer-implemented method of claim 1, wherein the first instruction is further associated with causing the second user interface to be displayed in a pop-up window on the display.

7. The computer-implemented method of claim 1, wherein the first instruction is further associated with causing a webpage or an application user interface to be populated with a hyperlink or selectable user interface element associated with causing the second user interface to be displayed.

8. The computer-implemented method of claim 1, wherein the first instruction is further associated with causing the second user interface to be displayed in connection with a push notification via the application installed on the user device.

9. The computer-implemented method of claim 1, wherein the receiving of the data further comprises:
receiving the data from the one or more computing systems comprising a travel service-related system; and
wherein the gathering of the additional data further comprises:
gathering the additional data from the one or more computing systems comprising a dining service-related system or an entertainment service-related system.

10. The computer-implemented method of claim 1, wherein the receiving of the data further comprises:
receiving the data prior to completion of the processing; and
wherein the sending of the first instruction further comprises:
sending the first instruction prior to completion of the processing.

11. A server device, comprising:
at least one memory storing instructions; and
at least one processor executing the instructions to perform operations for activity-related output, the operations comprising:
receiving, from a user device of an individual, data related to first input to a first user interface for an activity associated with a trip to a destination based on a selection of a user interface element to initiate processing of the first input;
gathering additional data based on receiving the data related to the first input,
the additional data comprising one or more prior activities of the individual and one or more activities of interest to the individual;
inputting the received data and the gathered additional data to one or more trained machine learning models,
first output from the one or more trained machine learning models, the first output comprising one or more characteristics of the destination or one or more characteristics of the one or more activities of interest;
generating, based on the first output from the one or more trained machine learning models, second output related to the activity, the second output comprising:
one or more alternative destinations, or
one or more events for the individual at the destination; and
sending a first instruction associated with causing a second user interface to be displayed on a display of the user device, the second user interface comprising the second output.

12. The server device of claim 11, wherein the additional data further comprises:
one or more prior activities of one or more other individuals at the destination.

13. The server device of claim 12, wherein the first output from the one or more trained machine learning models further comprises:
amounts of the one or more prior activities of the individual or the one or more prior activities of the one or more other individuals, or
one or more characteristics of the one or more prior activities of the individual or the one or more prior activities of the one or more other individuals.

14. The server device of claim 13, wherein the second output further comprises:
a total cost associated with the destination, or
one or more additional activities related to the destination.

15. The server device of claim 11, wherein the generating of the second output further comprises:
generating the second output using one or more other trained machine learning models or using one or more pre-defined rules.

16. The server device of claim 11, wherein the first instruction is further associated with causing the second user interface to be displayed in a pop-up window on the display.

17. The server device of claim 11, wherein the first instruction is further associated with causing a webpage or an application user interface to be populated with a hyperlink or selectable user interface element associated with causing the second user interface to be displayed.

18. The server device of claim 11, wherein the first instruction is further associated with causing the second user interface to be displayed in connection with a push notification via an application installed on the user device.

19. The server device of claim 11, wherein the receiving of the data further comprises:
receiving the data from one or more computing systems comprising a travel service-related system; and
wherein the gathering of the additional data further comprises:
gathering the additional data from the one or more computing systems comprising a dining service-related system or an entertainment service-related system.

20. A non-transitory computer-readable medium storing instructions that, when executed by a processor, cause the processor to perform a method for activity-related output, the method comprising:
receiving, by a server device and from a module or an application installed on a user device of an individual, data related to first input to a first user interface for an activity associated with a location based on selection of a user interface element to initiate processing of the first input;
gathering additional data based on receiving the data related to the first input;
inputting the received data and the gathered additional data to one or more trained machine learning models,
first output from the one or more trained machine learning models, the first output comprising one or more characteristics of the location or one or more characteristics of the one or more activities of interest;
generating, based on the first output from the one or more trained machine learning models, second output related to the activity, the second output comprising:
one or more alternative locations, or
one or more events for the individual at the location; and
sending a first instruction associated with causing a second user interface to be displayed on a display of the user device, the second user interface comprising the second output.
